(19) United States
(12) Patent Application Publication
(10) Pub. No.: US 2009/0182548 A1
(43) Pub. Date: Jul. 16, 2009

(54) HANDHELD DICTIONARY AND TRANSLATION APPARATUS

(76) Inventor: Jan Scott Zwolinski, Six Mile, SC (US)

Correspondence Address: TURNER PADGET GRAHAM & LANEY, P.A., P.O. BOX 1509, GREENVILLE, SC, 29602, US

(21) Appl. No.: 12/277,126

(22) Filed: Nov. 24, 2008

Related U.S. Application Data
(60) Provisional application No. 61/011,260, filed on Jan. 16, 2008.

(51) Int. Cl. G06F 17/28

(52) U.S. Cl. 704/3; 704/E13.001

(57) ABSTRACT

Provided herein is a dictionary and/or translation device that is handheld and, thus, portable. The device may be incorporated in or with a cellular telephone, a personal digital assistant (PDA), a pager, a handheld computer, or the like. A page of text (or a portion thereof may be photographed as a digital image, and the digitally photographed page may be converted to electronic text using an optical character recognition system. The converted text may be viewed on a display that includes a system for highlighting a word or words from the output of the optical character recognition system for definition or translation. The definition or translation of the highlighted word or words may be provided and output to either one of the display or an audio output (such as a speaker) or both.

### CROSS-REFERENCE TO RELATED APPLICATIONS

This application claims benefit of U.S. Provisional Patent Application No. 61/011,260 filed Jan. 16, 2008, which is incorporated herein by reference.

### TECHNICAL FIELD

The present disclosure is directed in general to a portable, handheld device for providing definitions and/or translations of digitally recorded text. In one configuration, the functionality for digitally recording text and providing a definition or translation of the text, or a portion thereof, may be incorporated into a cellular telephone, a personal digital assistant, a handheld computer, or the like.

### BACKGROUND

Readers frequently encounter words or phrases in reading material that they may not fully understand. When the reader cannot deduce the word's meaning from context clues, he or she may opt for utilizing either a conventional dictionary, a keypad-type electronic dictionary, or an online dictionary to ascertain the appropriate definition of the troublesome word. Each option has significant drawbacks. For instance, the conventional dictionary requires a reader to have access to what may be a relatively cumbersome book, which must be manipulated manually to locate the desired word. The keypad-type device requires the reader to type, or key, in the word for which a definition is sought. Readers seeking definitions on a computer must type the web address of an appropriate website or search engine, in addition to the desired word. In these latter cases, the need for additional technology and the sometimes accompanying technical challenges may leave a reader frustrated, particularly in those instances where the reader may be dyslexic or may have physical limitations (such as arthritis, for example) that make typing difficult.

Apart from the aforementioned electronic devices having a keypad, other electronic devices are available, which are configured with optical elements for scanning an unknown word. Exemplary devices, which require a scanning motion of their optics over the desired word(s), are described in International Patent Publication No. W098/03932; and U.S. Pat. Nos. 4,793,812; 4,890,230; 5,062,058; 5,648,760; 5,857,156; and 6,104,845. For instance, U.S. Pat. No. 4,890,230 is a tabletop unit, which has a scanner separate from its processor to scan text of a document. Similarly, U.S. Pat. No. 6,104,845 requires an optical scanning head to scan text, although the housing is in the form of a pen or wand, thus limiting the amount of text that may be readily scanned.

What the industry needs, and currently lacks, is a non-scanning device that can photographically or digitally record entire text passages, such as complete paragraphs, in a single action, such as by the press of a button, without the conventional scanning motions or equipment of known devices. The desired non-scanning device should be capable of using optical character recognition software to process the text on a word-by-word basis and of allowing the user to subsequently select all or portions of the recorded text passages for definition or translation.

### BRIEF SUMMARY

The present disclosure is directed generally to a dictionary and/or translation device that is handheld and, thus, portable. The device may be incorporated in or with a cellular telephone, a personal digital assistant (PDA), a pager, or a handheld computer. In general, a page of text (or a portion thereof) may be photographed as a digital image, and the digitally photographed page may be converted to electronic text using an optical character recognition system. The converted text may be viewed on a display that includes a system for highlighting a word or words from the output of the optical character recognition system for definition or translation. The definition or translation of the highlighted word or words may be provided and output to either one of the display or an audio output (such as a speaker) or both.

According to a particular aspect of the present disclosure, a portable handheld apparatus is provided, which includes a hand-holdable housing having an optical system configured to record text; an optical character recognition software disposed in the housing that is in electrical communication with the optical system and that converts the text to an output; a display for receiving the output of the optical character recognition software and that has a system for highlighting at least one word in the output; a corpus, or reference, disposed in the housing in electronic communication with the highlighted output; and a controller being configured to access a definition or translation of the highlighted output from the corpus and to direct the definition or translation to the display.

The apparatus may further include a optical system in the form of a camera, having a zoom lens; a software program for parsing the recorded text to provide a definition of a highlighted word appropriate to the context; a touch screen display; a scroll wheel; and/or a depressible highlight bar.

A method of acquiring a definition or translation of a word, using a non-scanning, handheld apparatus, includes providing a handheld apparatus having an optical system configured to record text and a display configured as a user interface for selecting text; loading OCR software in the handheld apparatus, the OCR software being in electronic communication with the optical system; loading reference software, or a corpus, in the handheld apparatus, the reference software being in electronic communication with the OCR software; photographing the text; directing the text to the OCR software, which is configured to convert the text to an output and show the output on a display; selecting at least one word from the output with the user interface; accessing the word in the reference software; and providing a definition or translation of the word to a user.

The method may also include loading the software onto the device via a wireless connection to a host source, a cable connection to a host source, or an insertion of a memory card into the apparatus; parsing the text to provide a contextually relevant definition or translation; providing the handheld apparatus with an optical system in the form of a camera and isolating portions of the text using a zoom feature of the camera; providing the display with a touch screen and providing a program for highlighting the text touched by the user on the touch screen; providing the definition or translation of the word to the user on the display; and/or providing the apparatus with a speaker and providing the definition or translation of the word to the user by the speaker.

Evident from the foregoing introduction, the component parts of the present handheld device are simple and economical to manufacture and use. Other advantages of the disclosure will be apparent from the following description and the attached drawing or can be learned through practice of the present subject matter.

Additional objects and advantages of the present subject matter are set forth in, or will be apparent to, those of ordinary skill in the art from the detailed description herein. Also it should be further appreciated that modifications and variations to the specifically illustrated, referenced, and discussed features and elements hereof may be practiced in various embodiments and uses without departing from the spirit and scope of the subject matter. Variations may include, but are not limited to, substitution of equivalent means, features or steps for those illustrated, referenced or discussed, and the functional, operational, or positional reversal of various parts, features, steps or the like.

Still further, it is to be understood that different embodiments, as well as different presently preferred embodiments, of the present subject matter may include various combinations or configurations of presently disclosed features, steps or elements or their equivalents (including combinations of features, parts, or steps or configurations thereof, not expressly shown in the figures or stated in the detailed description of such figures). Additional embodiments of the present subject matter, not necessarily expressed in the summarized section, may include and incorporate various combinations of aspects of features, components, or steps referenced in the summarized objects above. Those of ordinary skill in the art will better appreciate the features and aspects of such embodiments, and others upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a schematic view of a handheld dictionary and translation device shown in intended use according to one aspect of the disclosure; and

FIG. 2 is a flow chart showing an operation matrix of the handheld dictionary and translation device of FIG. 1.

### DETAILED DESCRIPTION

Detailed reference will now be made to the drawings in which examples embodying the present subject matter are shown. The detailed description uses numerical and letter designations to refer to features of the drawings. Like or similar designations of the drawings and description have been used to refer to like or similar parts of various exemplary embodiments.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed description are provided by way of explanation only and are not meant as limitations of the disclosure. The present subject matter thus includes any modifications and variations of the following examples as fall within the scope of the appended claims and their equivalents.

It is to be understood by one of ordinary skill in the art that the following discussion simply describes exemplary embodiments and is not intended as limiting the broader aspects of the present disclosure.

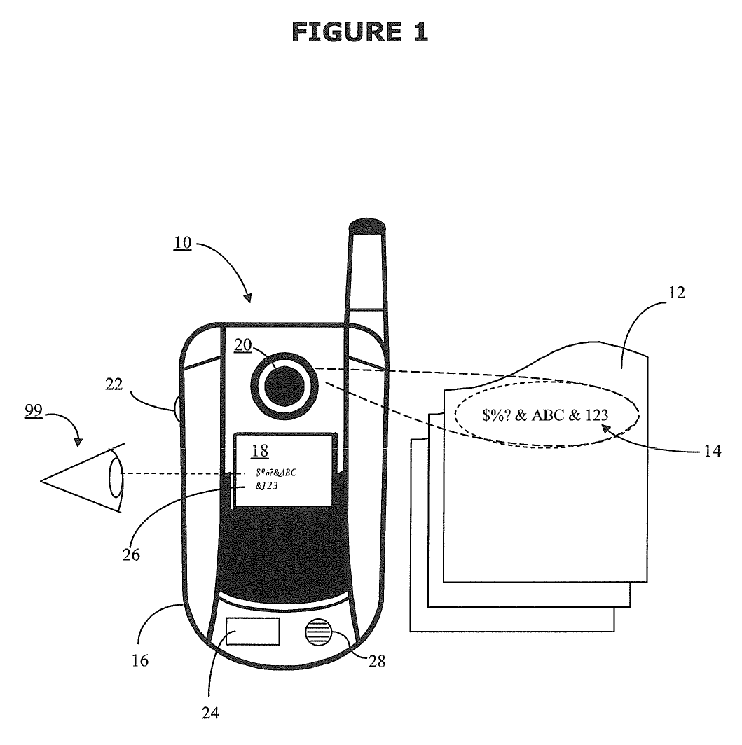

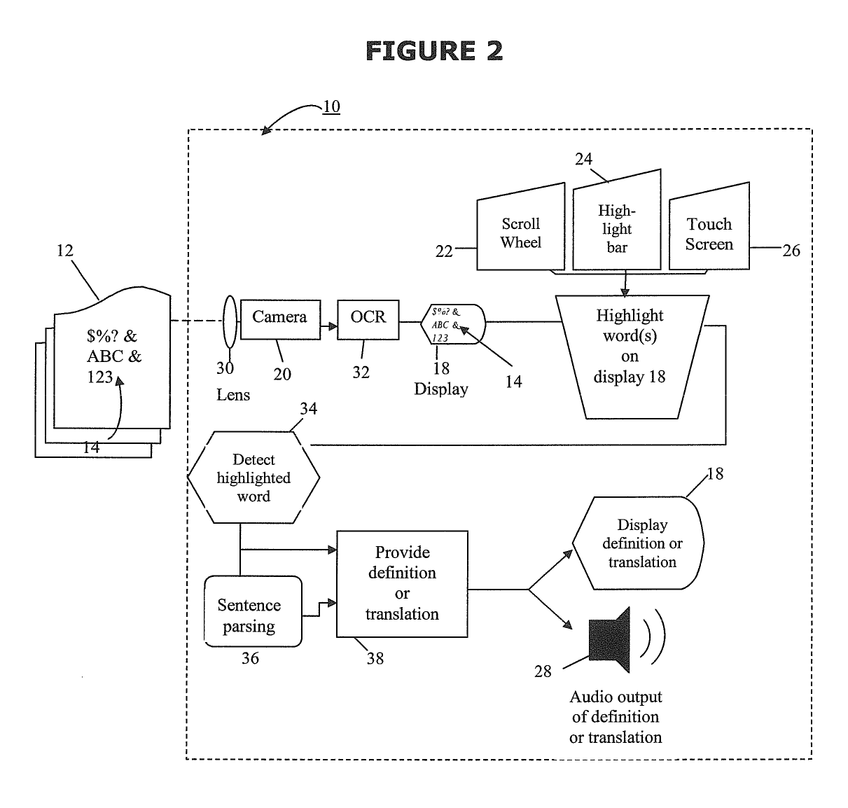

FIGS. 1 and 2 show various aspects of a handheld device or apparatus designated in general by the element number 10. The handheld apparatus 10 may be utilized for imaging written or printed alphabetic or alphanumeric materials 12, such as are found in a magazine, a book, a paper, or other document, in order to capture, record, define and/or translate text 14 of the materials 12; e.g., an individual word, multiple words or larger sections of text such as paragraphs or whole pages. As will be described in detail below, the handheld apparatus 10 obviates the necessity for any scanning motion of the device or optics over the text 14 by a user 99, thus simplifying its use. Further, the apparatus 10 functions without the need for optical scanning heads or associated hardware and software. As will become evident from the following description, various components of the handheld apparatus 10 are lightweight, compact and may be easily serviced and/or replaced to extend a service life of the handheld apparatus 10.

With particular reference to FIG. 1, the handheld apparatus 10 may be a cellular phone, a personal digital assistant, or other similar portable electronic device. In general, the apparatus 10 may include a housing 16 configured to be handheld and readily portable. The handheld apparatus 10 may further include a display 18, optics such as a camera 20, a thumbwheel or roller 22, a highlighting button or bar 24 and a touch screen 26, which may or may not be separate from the display 18. As shown in this example, the camera 20 may be located conveniently on and/or in the housing 16 to photograph or digitally record a page of the text 14. Those skilled in the art will understand that the camera 20 is not limited to the exemplary position and may be located elsewhere in or on the housing 16, such as on an edge, reverse side, or the like.

FIG. 1 further shows that the text 14 is digitally recorded for input to an optical character reader 32 (as shown in FIG. 2), which translates the digitally recorded text 14 into alphanumeric characters, such as ASCII (American Standard Code for Information Interchange) characters. The characters are shown on the display 18 of the handheld apparatus 10 for consideration by the user 99 and subsequent manipulation as described below.

The embodiment shown in FIG. 1 may be better understood with reference to an exemplary operation of the handheld apparatus 10. In this example, the entire text 14 is digitally photographed and recorded by the user 99 using the camera 20. In one aspect, the user 99 may view the targeted text 14 through the camera 20 (which, in this example, “sees” the text 14 via a lens 30, as shown in FIG. 2). Once the user 99 has targeted the desired text 14, which could be the entire page 12 depending upon focal point, the user 99 may depress the scroll wheel 22 or other action button and record the targeted text 14. The handheld apparatus 10 obviates the necessity for providing any scanning motion over the word or words since the camera 20 simply takes a “picture” of the targeted text 14, whether a single word or entire page 12, depending upon the size of the text 14, the focal length of the camera 20, and the distance between the camera 20 and the page 12.

The digital photograph, or image, of the targeted text 14 is converted to an electronic, editable output using optical character recognition (“OCR”) software loaded within the apparatus 10, and the OCR output appears on the display 18. The user 99 may then select portions of the text 14 (in OCR format on the display 18) using highlighting or other designation techniques, which may be processed on a word-by-word basis, by virtue of the text 14 having been converted from a fixed image into an OCR output.

There are several methods possible for highlighting, or selecting, the specific text 14 on the display 18, and the apparatus 10 may include any or all of the tools used to enable these methods. For instance, the user 99 may use the highlight bar 24 to highlight the desired text 14. Additionally or alternatively, the thumb wheel 22 may be used to scroll quickly between words and paragraphs of the text 14, and the wheel 22 or bar 24 may be depressed to highlight a desired word. Still further, the user 99 may select words by moving a cursor on the display 18, for instance, to a particular word or sentence of the text 14. As briefly introduced above, the handheld apparatus 10 may be provided with the touch screen 26 and a computer software program (as shown in FIG. 2) to allow the user 99 to highlight an individual word 14 on the touch screen 26, with the program sensing the highlighted word 14.

Thus, sentences or portions of sentences may be highlighted, and software that disambiguates sentences may be utilized to understand the context in which the word is used in the sentence, thus providing more accurate definitions or translations. Such contextual reference may be achieved through the use of speech parsing techniques common in speech recognition software. Exemplary parsing software is described in U.S. Pat. No. 5,383,120, which teaches context-specific parsing; and in U.S. Pat. No. 6,697,801, which teaches parsing of words that include non-alphabetic characters (such as hyphens), the disclosures of which are hereby incorporated by reference.

In the embodiment of FIG. 1, a reference (such as a dictionary, foreign language dictionary, thesaurus, Grey's Corpus, or the like) is saved in the programmed software to provide a definition or translation of the highlighted text 14. The highlighted text 14 may be shown on the display 18 in juxtaposition to the definition or translation and/or the definition or translation may be announced to the user 99 via a speaker 28.

Evident from the foregoing discussion, the handheld apparatus 10 obviates the necessity for providing any scanning motion of a device or optics over the printed text 14 in the document 12. Additionally, the dictionary definition or translation of a word in the text 14 can be made to be dependent upon the use of the word or phrase in a sentence, thus providing more accurate definitions or translations, as well as limiting the number of choices that the user 99 might have to review to obtain the appropriate definition or translation. Stated another way, an entire sentence may be recorded so that the parsing software can “understand”, or consider, the context of a highlighted word to provide a more accurate definition or translation.

Turning now to FIG. 2, the handheld apparatus 10 is used to photograph, or record, a document 12, or portions thereof, as introduced above. The camera 20 may include a lens 30 and may be in communication with OCR software 32 loaded in the apparatus 10. By way of example and not of limitation, Expervision of Fremont, Calif. offers OCR software, such as TypeReader®, which might be used as the software 32. Other suppliers having suitable OCR software include, but are not limited to, Nuance Communications of Burlington, Mass. and Readiris of Belgium.

The apparatus software used to capture, convert, and output the text 14 and to retrieve and provide its definition or translation may be pre-loaded onto the apparatus 10 (for example, cell phone or PDA), as an additional feature of the apparatus, before the sale of the apparatus to the user. Another approach is for the user to purchase a memory card containing the application software and to load the software onto an apparatus 10 by inserting the memory card into a corresponding slot in the apparatus 10. Using this approach, the user may add translation capability into one or more different languages by inserting different memory cards. Alternately, the software may be added to the apparatus 10 by a wireless connection to a host source, such as an Internet Service Provider or a cellular telephone and wireless internet service provider, or a cable connection to a host source, such as a personal computer. For example, the user may download the software to his personal computer and transfer the software to the apparatus 10 by synchronizing the apparatus 10 and his computer files.

As shown, the display 18 reflects a facsimile of the text 14 captured by the camera 20. As noted above, the user 99 may highlight the desired text 14 on the display 18 using the thumb wheel 22, the highlight bar 24, the touchscreen 26, or some other method (e.g., a cursor). In one aspect, the wheel 22 or the bar 24 may be used to “zoom” the camera 20 to a specific word or word in the text 14. After the desired text 14 is targeted by the user 99, software 34, 36 will detect the word (34) and parse the host sentence (36) as necessary and provide the desired definition or translation 38. As further noted above, the desired definition and/or translation may be displayed on the display 18. Additionally, or alternately, the user 99 may receive an audible definition and/or translation via the speaker 28.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is provided by way of example rather than by way of limitation, and the subject disclosure does not preclude inclusion of such modifications, variations and/or additions to the present subject matter as would be readily apparent to one of ordinary skill in the art.

That which is claimed is:

1. A portable handheld apparatus comprising:
a hand-holdable housing having an optical system being configured to record text;
optical character recognition software disposed in the housing in electronic communication with the optical system, the optical character recognition software being configured to convert the text to an output;
a display for receiving the output, the display having a system for highlighting at least one word in the output;
a corpus disposed in the housing in electronic communication with the highlighted output; and
a controller being configured to access a definition or translation of the highlighted output from the corpus and to direct the definition or translation to the display.

2. The apparatus of claim 1, further comprising a software program for parsing the recorded text to provide a definition or translation of the at least one highlighted word in the recorded text based on text context.

3. The apparatus of claim 1, wherein the optical system is a camera and includes a zoom for isolating portions of the text on the page to be processed.

4. The apparatus of claim 1, wherein the display includes a touch screen display and a program for highlighting the text touched.

5. The apparatus of claim 1, further comprising a scroll wheel.

6. The apparatus of claim 1, further comprising a depressible highlight bar.

7. A method of acquiring a definition or translation of a word with a non-scanning, handheld apparatus, comprising:
providing a handheld apparatus including an optical system being configured to record text and a display being configured as a user interface for selecting text;
loading optical character recognition software in the handheld apparatus, the optical character recognition software being in electronic communication with the optical system;
loading reference software in the handheld apparatus, the reference software being in electronic communication with the optical character recognition software;
photographing the text;
directing the text to the optical character recognition software, the optical character recognition software being configured to convert the text to an output and showing the output on the display;
selecting at least one word from the output with the user interface;
accessing the word in the reference software; and
providing a definition or translation of the word to a user.

8. The method of claim 7, further comprising loading the optical character recognition software and the reference software onto the apparatus by one of a wireless connection to a host source, a cable connection to a host source, and an insertion of a memory card into the apparatus.

9. The method of claim 8, wherein the host source for the wireless connection is an Internet Service Provider.

10. The method of claim 8, wherein the host source of the cable connection is a personal computer.

11. The method of claim 7, further comprising parsing the text to provide the definition or translation of the word in the text based on text context.

12. The method of claim 7, further comprising providing the optical system in the form of a camera and isolating portions of the text to be processed using a zoom feature of the camera.

13. The method of claim 7, further comprising providing the display with a touch screen display and providing a program for highlighting the text touched by the user.

14. The method of claim 7, further comprising providing the definition or translation of the word to the user on the display.

15. The method of claim 7, further comprising providing the apparatus with a speaker and providing the definition or translation of the word to the user by the speaker.
